(19) United States
(12) Patent Application Publication
(10) Pub. No.: US 2016/0283718 A1
(43) Pub. Date: Sep. 29, 2016

(54) INFORMATION PROCESSING DEVICE AND INFORMATION PROCESSING METHOD

(71) Applicant: NIDEC SANKYO CORPORATION, Nagano (JP)

(72) Inventor: Tsutomu BABA, Nagano (JP)

(21) Appl. No.: 15/080,917

(22) Filed: Mar. 25, 2016

(30) Foreign Application Priority Data
Mar. 27, 2015 (JP) 2015-067158

(51) Int. Cl. G06F 21/57

(52) U.S. Cl. CPC G06F 21/57; G06F 2221/034

(57) ABSTRACT

An information processing device may include a master circuit; and a security circuit. The master circuit may include a status checking circuit configured to repeatedly send a status check command to the security circuit; and a status check information receiving circuit configured to receive status check information from the security circuit, the status check information being in response to the status check command sent by the status checking circuit. The security circuit may include a security inspection circuit configured to periodically execute a security inspection; and a status check information sending circuit configured to send status check information indicating an advance notice of executing the security inspection, to the master circuit, as a response to the status check command, at a time just before a specific timing for executing the security inspection by the security inspection circuit.

### CROSS REFERENCE TO RELATED APPLICATION

The present application claims priority under 35 U.S.C. §119 to Japanese Application No. 2015-067158 filed Mar. 27, 2015, the entire content of which is incorporated herein by reference.

### FIELD OF THE INVENTION

At least an embodiment of the present invention relates to an information processing device and an information processing method; and in particular, relates to an information processing device including a master device and a security device, and moreover relates to an information processing method thereof.

### BACKGROUND

Conventionally, there exists an information processing device provided with a plurality of control units, the information processing device including a master (main) device and a slave device to be controlled by the master device. In such an information processing device, for example, the master device sends an instruction (a command) to the slave device. Having received the command, the slave device sends the master device a response to the command.

Furthermore, in such an information processing device, there exists something to monitor status of the slave device, in the master device. When Patent Document 1 is referred to, there is described an information processing system, in which a slave device provided with a slave processor includes; an error detection means for detecting the slave processor being in abnormal condition in accordance with a detection status on a signal output from the slave processor; a reset signal output means for outputting a reset signal in order to reset an operation status of the slave processor, in the case where the slave processor is detected being in abnormal condition; and an error judgment means for making a judgment that the slave processor is out of order, in accordance with the number of detections of the slave processor being in abnormal condition, and notifying a master processor of the master device of the judgment.

In the meantime, if a slave device is a security device for materialization of a security function for encoding operation and decoding operation, it is necessary to periodically execute a security inspection for confirming security-wise safety of the security device. For such a security inspection, there is a method of checking the security in which a control unit of the security device carries out resetting on its own (hereinafter, called “self-resetting”) by means of software, and the security is checked during an initializing process.

### PATENT DOCUMENT

Patent Document 1: Japanese Unexamined Patent Application Publication No. 2014-149591

In this case, at a time when the security device executes self-resetting and the like in the security inspection, the master device has a communication failure in which no communication can be carried out in relation to the security device. Unfortunately, in the meantime, there is a problem in a technology described in Patent Document 1 that it cannot be judged whether the security inspection is in process, or the security device is out of order. Therefore, the master device could possibly misunderstand it in such a way that the security device has a hardware error, as a result of that the information processing device as a whole cannot operate stably.

### SUMMARY

Then, at least an embodiment of the present invention provides an information processing device in which a master device notices that a security device carries out a security check in such a way as to increase operation stability.

An information processing device according to at least an embodiment of the present invention is an information processing device including a master device and a security device, characterized in that; the master device comprises: a status checking means for repeatedly sending a status check command to the security device; and a status check information receiving means for receiving status check information from the security device, the status check information being in response to the status check command sent by the status checking means; and the security device comprises: a security inspection means for periodically executing a security inspection; and a status check information sending means for sending status check information indicating an advance notice of executing the security inspection, to the master device, as a response to the status check command, at a time just before a specific timing for executing the security inspection by the security inspection means. According to this configuration, it becomes possible to judge whether a status is in a security inspection or owing to the security device being out of order, so that stability of the device can be improved.

In the information processing device according to at least an embodiment of the present invention; it is preferable that the security inspection means of the security device executes a security inspection at the time of startup, by means of periodically carrying out self-resetting. According to this configuration, a communication failure caused by the self-resetting can be avoided, and stability can be improved.

In the information processing device according to at least an embodiment of the present invention; it is preferable that, in the case where status check information received by the status check information receiving means indicates an advance notice of executing the security inspection, the status checking means of the master device suspends transmission of the command for a period of the specific time and a process time for the security inspection. According to this configuration, processing efficiency of the security inspection can be improved.

In the information processing device according to at least an embodiment of the present invention; it is preferable that the master device includes a status check disabled response notifying means for making a response to an outside, notifying that the command cannot be executed, in the case of having received the command to be executed by the security device, from the outside, during the command transmission suspension time by the status checking means. According to this configuration, it becomes possible to prevent an outside device from wrongly recognizing a breakdown of the security device so as to stop operation, and therefore stability can be improved.

An information processing method according to the present is an information processing method to be executed by an information processing device including a master device and a security device, characterized in that; the master device repeatedly sends a status check command to the security device; and the master device receives status check information, being in response to the sent status check command, from the security device; and the security device periodically executes a security inspection; and the security device sends status check information notifying of executing the security inspection, to the master device, as a response to the status check command, at a time just before a specific timing for executing the security inspection. According to this configuration, it becomes possible to judge whether a status is in a security inspection or owing to the security device being out of order, so that stability can be improved.

### Advantageous Effect of the Invention

According to at least an embodiment of the present invention, at a time just before a specific timing for executing a security inspection, the security device sends status check information to the master device in such a way that the master device notices that the security device is about to carry out the security inspection, and then the master device can judge whether the security inspection is in process, or the security device is out of order. Accordingly, it becomes possible to provide an information processing device having increased operation stability.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a system configuration diagram of an information processing system according to an embodiment of the present invention.

FIG. 2 is a flowchart of a command handling process of a master device according to the embodiment of the present invention.

FIG. 3 is a flowchart of a command execution process of a slave device according to the embodiment of the present invention.

### DETAILED DESCRIPTION

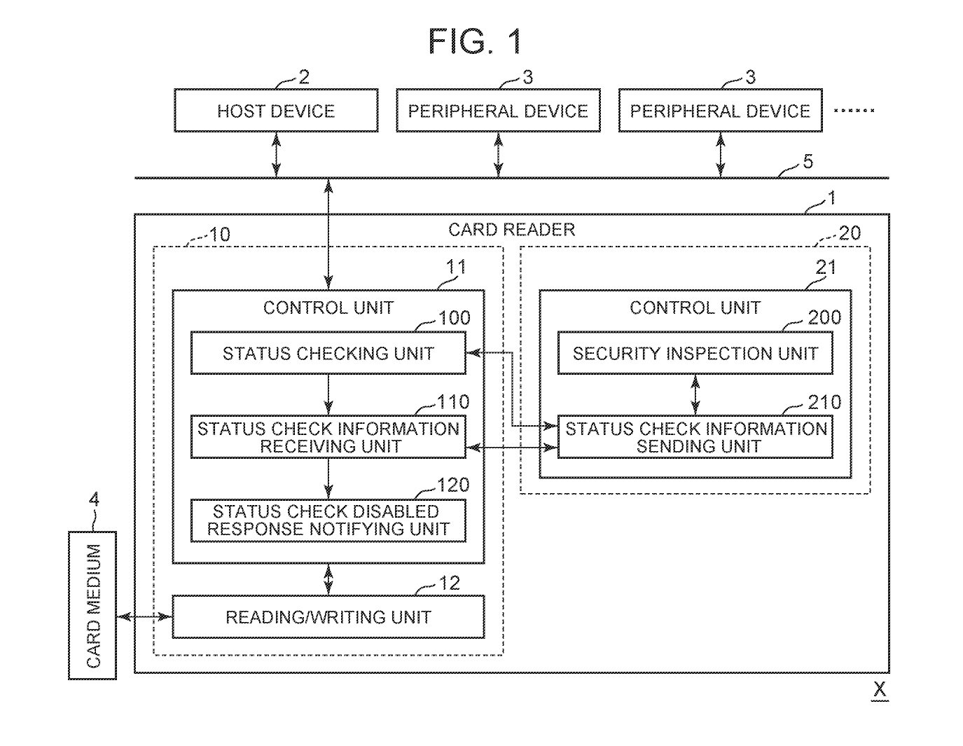

A configuration of an information processing system ‘X’ according to an embodiment of the present invention is explained below with reference to FIG. 1.

In the present embodiment, the information processing system ‘X’ is such a system as; an automated teller machine (ATM) provided with a card issuing function, a terminal of a kiosk, a ticket issuing system of transportation facilities, a point card issuing system of a convenience store and so forth, a member card issuing system of a retailing store, a card issuing & cash-dispensing system of a play machine, an entrance-and-exit control system, and the like (hereinafter, simply referred to as an “ATM and the like” in an abbreviated manner).

Incidentally, the information processing system ‘X’ includes a card reader 1 (an information processing device), a host device 2, and a peripheral device 3. Meanwhile, each of the above units is connected by way of a communication line 5.

The card reader 1 is a device that can read out of, or write into a card medium 4; wherein the card medium 4 is an IC card of a contact type or a non-contact type, and/or a magnetic card provided with a magnetic stripe. A detailed configuration of the card reader 1 is described later.

The host device 2 is a main body unit for materializing each function of the ATM and the like. The host device 2 includes a control arithmetic unit; such as a personal computer (PC), a tablet computer terminal, a cellular phone, and so forth; for controlling each unit. Then, the host device 2 executes an application (application program that is not shown) for materializing a function of the information processing system ‘X’.

The peripheral device 3 is, for example, a printer for printing or stamping on a surface of the card medium 4; a display, a touch panel, and keys of an LCD panel, an organic electroluminescence panel and so on; and so forth.

The communication line 5 is a general-purpose bus, a serial interface line, a parallel interface line, an IP network, and the like. The communication line 5 makes it possible to send and receive information including various instructions (commands) and data, among relevant units.

Moreover, the card reader 1 is also an information processing device including a master device 10 and a security device 20.

The master device 10 includes, for example, various circuits placed on a main board, for controlling an entire section of the card reader 1. The master device 10 controls the security device 20, being connected, by way of communication.

The security device 20 is a security board to be connected to the master device 10, being an example of a slave device. The security device 20 includes various circuits for materializing a security function of the card reader 1; and the security device 20 is configured, for example, in conformity with PCI (Payment Card Industry) standards. The security device 20 is provided with, for example, a data encoding function in order to prevent security data; such as an ID, a personal identification number, a password, and the like which are stored in the card medium 4; from being swindled fraudulently, a decoding function, a detection function for detecting an illegal modification of the card reader 1, and the like.

Therefore, the security device 20 executes a security inspection, such as checking security independently and regularly in accordance with the PCI standards, being not pursuant to an instruction coming from the master device 10. Meanwhile, in the security device 20, there may be connected a sensor in order to detect a cabinet of an information system getting opened, and the card reader 1 being removed or modified, and the like.

Being described in detail, the master device 10 includes a control unit 11, and a reading/writing unit 12. In the meantime, the security device 20 is provided with a control unit 21.

The control unit 11 is a control arithmetic means; being such as a central processing unit (CPU), a micro processing unit (MPU), a graphics processing unit (GPU), a digital signal processor (DSP), an application specific integrated circuit (ASIC), and the like. Meanwhile, the control unit 11 has a timer built-in, which externally includes a crystal oscillator and an oscillation circuit.

Incidentally, the control unit 11 includes a non-volatile storage medium; such as a random access memory (RAM), a read only memory (ROM), a flash memory, and the like. The storage medium of the control unit 11 stores a control program for the control unit 11 mounted on a main board. In the control program, there are included processes of; such as monitoring a sensor for detecting the card medium 4, reading out of & writing into the card medium 4, controlling the security device 20, and the like. Moreover, the storage medium of the control unit 11 also keeps in memory a specific periodical time interval (hereinafter, called a “specific time interval”) for periodically checking status of the control unit 21. As the specific time interval for checking the status, a time interval in a range from several milli-seconds to several minutes can be kept in memory in the storage medium.

The reading/writing unit 12 includes a magnetic head, an electromagnetic induction coil, a terminal, and the like, for reading out of & writing into the card medium 4. Furthermore, the reading/writing unit 12 also includes a sensor for detecting the card medium 4, a driving mechanism, and the like.

The control unit 21 is a control arithmetic means; being such as a CPU, an MPU, a GPU, a DSP, an ASIC, and the like. The control unit 21 may include an accelerator that exclusively executes a hashing operation for various kinds of encoding and decoding operations, by way of a method of Advanced Encryption Standard (AES). Furthermore, the control unit 21 has an own timer built-in.

Incidentally, the control unit 21 includes a non-volatile storage medium; such as a RAM, a ROM, a flash memory, and the like. The storage medium of the control unit 21 stores a control program for the control unit 21. Moreover, the storage medium of the control unit 21 also stores a key for an encoding operation, and a hashing value and a cyclic redundancy code value (CRC value) for a security inspection. Moreover, the storage medium of the control unit 21 also keeps in memory a specific time of an inspection interval (hereinafter, called a “specific inspection time interval”), for example, in an approximate range from several hours to one day, in order to periodically execute self-resetting. Concretely to describe, the control unit 21 gets self-reset, if once the specific inspection time interval elapses after an initialization and a completion of a security inspection. Moreover, the storage medium of the control unit 21 keeps in memory a specific time for a countdown in order to notify the master device that it is the timing just before self-resetting. As the specific time, a time period being longer; for example, in an approximate range from several seconds to several tens of seconds; than the specific time interval for checking the status, can be kept in memory in the storage medium.

Furthermore, the control unit 21 is able to obtain information coming from a sensor with which the master device 10 or another device is provided.

To describe more in detail, the control unit 11 of the master device 10 is provided with; a status checking unit 100 (a status checking means), a status check information receiving unit 110 (a status check information receiving means), and a status check disabled response notifying unit 120 (a status check disabled response notifying means); as blocks for configuring the functions.

The status checking unit 100 repeatedly sends the security device 20 a command requesting to send status check information (hereinafter, called a ‘status check command’). Specifically to describe, the status checking unit 100 sends the status check command to the security device 20, at intervals of the specific time interval.

Moreover, in addition to sending the status check command, the status checking unit 100 controls each of units including the security device 20, in response to a command sent from the host device 2 and the peripheral device 3 (hereinafter, called an ‘ordinary command’). Furthermore, in the case where it is needed to encode or decode a datum, the status checking unit 100 sends the security device 20 a command and a datum that are necessary.

Moreover, in the case where status check information obtained from the status check information receiving unit 110 indicates an advance notice of executing a security inspection, the status checking unit 100 suspends transmission of a command, for a period of a specific time for a countdown and a process time for the security inspection.

Incidentally, the process time for the security inspection is used for measuring a time period that is longer than an interval; which lasts from starting self-resetting of the security device 20, through completion of various diagnosis operations, until a response to an ordinary command becomes enabled; and the process time for the security inspection can be set in the storage medium of the control unit 11 of the master device 10. Hereinafter, the period including the specific time for a countdown and the process time for the security inspection is called a “command transmission suspension time.” Referring to the timer, the status checking unit 100 suspends transmission of a command, for the specified command transmission suspension time. In the meantime; commands, of which the status checking unit 100 suspends transmission, include a status check command and an ordinary command.

The status check information receiving unit 110 receives status check information from the security device 20, the status check information being in response to a status check command sent from the status checking unit 100. In this way, it becomes possible in the master device 10 to monitor a status of the security device 20 at all times.

In the case of having received externally a command from outside to be executed by the security device 20, during the command transmission suspension time by the status checking unit 100; the status check disabled response notifying unit 120 makes a response to the outside in order to notify that the command cannot be executed. As a concrete example, at a time of having received an ordinary command from the host device 2 or the peripheral device 3, the status check disabled response notifying unit 120 makes a response (hereinafter, called an “execution disabled response”) by using a ‘busy signal’ and the like meaning that the device is in process, in order to notify that the command cannot be executed.

Incidentally, the execution disabled response may be made in such a way that it is impossible to judge whether the security device 20 is busy simply because of the device being in an arithmetic process of an encoding/decoding operation, or because of the device being in a process of a security inspection. By making a configuration in this way, a fact that the device is in a process of a security inspection can be concealed so as to improve security.

Moreover, the control unit 21 of the security device 20 is provided with a security inspection unit 200 (a security inspection means), and a status check information sending unit 210 (a status check information sending means), as blocks for function configuration.

The security inspection unit 200 periodically executes a security inspection. As a concrete example of the security inspection, there is executed a self-check according to the PCI standards, and the like, for confirming security-wise safety of the security device 20 in itself. Moreover to describe, while setting a timer that is built in the security device 20, the security inspection unit 200 executes the security inspection at a time when the specific inspection time interval elapses. A value for the specific inspection time interval is specified in a ROM, a flash memory, and the like, as the storage medium of the control unit 21, in accordance with the PCI standards, and the like.

Furthermore, by way of execution of self-resetting at regular intervals, the security inspection unit 200 executes a security inspection at the time of start-up. When it is judged by use of the timer that the specific inspection time interval has elapsed, the security inspection unit 200 executes the control program from its beginning by way of self-resetting. The security inspection unit 200 executes a security check for each unit, authenticity checking on a program and a datum, and the like, as the security inspection, in the course of a series of initialization steps at the time of restart.

At a time just before a specific timing of countdown for executing a security inspection by the security inspection unit 200, the status check information sending unit 210 sends status check information indicating an advance notice of executing the security inspection, to the master device 10. In this way, the master device 10 can be notified of the timing just before the self-resetting. Meanwhile, the status check information sending unit 210 receives an ordinary command, and executes a process with respect to the command, and makes a response with a result. Moreover, in the case where the result of the security inspection is inadequate, or any of units is broken; the status check information sending unit 210 detects such a problem, and makes a response.

### (Command Handling Process by the Master Device 10)

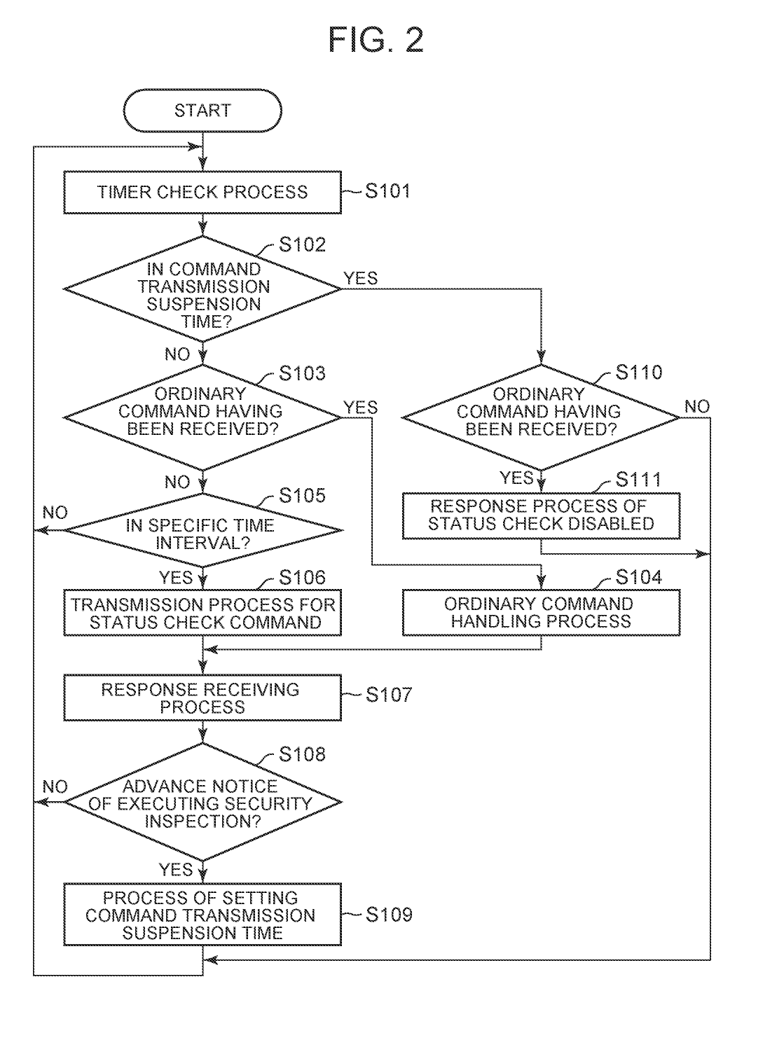

Next, a command handling process to be executed by the master device 10 according to the embodiment of the present invention is explained with reference to FIG. 2.

In the command handling process according to the present embodiment, a status check command is repeatedly sent to the security device 20 at regular intervals. In the meantime, status check information, in response to the status check command that has been sent, is received from the security device 20. Then, in the case where the received status check information indicates an advance notice of executing a security inspection, and it is in the command transmission suspension time, command transmission is suspended. During the command transmission suspension time; if a command to be executed by the security device 20 is received from the outside, a response is made to the outside in order to notify that the command cannot be executed. The command handling process according to the present embodiment is executed in collaboration with each unit by using a hardware resource, while the control unit 11 of the master device 10 mainly executes the control program that is stored in the built-in storage medium. Each step of an operation log storing process is explained below in detail, with reference to the flowchart of FIG. 2.

### (Step S101)

At first, the status checking unit 100 carries out a timer check process.

The status checking unit 100 reads out a value of the built-in timer, and checks whether a command transmission suspension time is specified, and whether it is in a specific time interval for checking the status.

### (Step S102)

Then, the status checking unit 100 makes a judgment on whether or not it is in the command transmission suspension time. In the case where a command transmission suspension time is specified, and the command transmission suspension time has not yet elapsed, the status checking unit 100 makes a judgment with ‘Yes’. Then, in any other case, the status checking unit 100 makes a judgment with ‘No’.

In the case of ‘Yes’, the status checking unit 100 moves operation to Step S110.

In the case of ‘No’, the status checking unit 100 moves operation to Step S103.

### (Step S103)

If it is not in the command transmission suspension time, the status checking unit 100 judges whether or not an ordinary command has been received. In the case where an ordinary command has been received from the host device 2 and/or the peripheral device 3, the status checking unit 100 makes a judgment with ‘Yes’. If no ordinary command has been received, the status checking unit 100 makes a judgment with ‘No’.

In the case of ‘Yes’, the status checking unit 100 moves operation to Step S104.

In the case of ‘No’, the status checking unit 100 moves operation to Step S105.

### (Step S104)

If an ordinary command has been received, the status checking unit 100 carries out an ordinary command handling process. The status checking unit 100 executes the process corresponding to the ordinary command received. In this case, it is also possible for the status checking unit 100 to send a command and data to the security device 20. As a concrete example, in the case where a process of data encoding/decoding operation and the like is necessary, the status checking unit 100 sends the data required for the command to the security device 20.

### (Step S105)

If no ordinary command has been received, the status checking unit 100 judges whether or not it is in the specific time interval for checking the status. In the case where a value read out from the timer is a value corresponding to the specific time interval, the status checking unit 100 makes a judgment with ‘Yes’. Then, in any other case, the status checking unit 100 makes a judgment with ‘No’.

In the case of ‘Yes’, the status checking unit 100 moves operation to Step S106.

In the case of ‘No’, the status checking unit 100 returns operation to Step S101 to continue reading out the timer.

### (Step S106)

In the case where the timer indicates a value corresponding to the specific time interval for checking the status, the status checking unit 100 carries out a transmission process for a status check command.

The status checking unit 100 sends a status check command to the security device 20. By means of repeatedly sending a status check command to the security device 20 in this way, it becomes possible to periodically monitor the status of the security device 20.

### (Step S107)

At this time, the status check information receiving unit 110 carries out a response receiving process.

The status check information receiving unit 110 receives status check information with respect to the status check command, as a response. Moreover, while detecting the card reader 1 having been dismounted from the information processing system ‘X’, or having been disassembled for illegal modification, on the basis of the status check information; the status check information receiving unit 110 can notify the host device 2 and the like, of the incident.

The status check information receiving unit 110 receives a datum such as a calculation result and the like, created by the control unit 21 of the security device 20, as a response with respect to the ordinary command. The status check information receiving unit 110 can also receive another datum, a command and the like, as a response with respect to the ordinary command. Moreover, the status check information receiving unit 110 can obtain an advance notice of executing a security inspection, also in a response of the ordinary command. Furthermore, according to the contents of such a response, the status check information receiving unit 110 can carry out sending and controlling a datum to the host device 2 and the peripheral device 3.

### (Step S108)

Next, the status checking unit 100 makes a judgment on whether or not there exists an advance notice of executing a security inspection. In the case of having received status check information indicating an advance notice of executing a security inspection, the status checking unit 100 makes a judgment with ‘Yes’. Then, in any other case, the status checking unit 100 makes a judgment with ‘No’.

In the case of ‘Yes’, the status checking unit 100 moves operation to Step S109.

In the case of ‘No’, the status checking unit 100 returns operation to Step S101 to continue checking the timer.

### (Step S109)

In the case of having received an advance notice of executing a security inspection, the status checking unit 100 carries out a process of setting a command transmission suspension time.

In the case of having received an advance notice of executing a security inspection, the status checking unit 100 sets a command transmission suspension time. According to this setting process, the master device 10 suspends a command transmission during the specific time for a countdown and the process time for the security inspection. Subsequently, the status checking unit 100 returns operation to Step S101 to continue checking the timer. Incidentally, the master device 10 restarts the command transmission after the command transmission suspension time elapses.

### (Step S110)

At this time, even in the case where the command transmission suspension time is set, the status check disabled response notifying unit 120 makes a judgment on whether or not an ordinary command has been received. In the case where an ordinary command has been received from the host device 2 and/or the peripheral device 3, the status check disabled response notifying unit 120 makes a judgment with ‘Yes’. Then, in any other case, the status check disabled response notifying unit 120 makes a judgment with ‘No’.

In the case of ‘Yes’, the status check disabled response notifying unit 120 moves operation to Step S111.

In the case of ‘No’, the status check disabled response notifying unit 120 returns operation to Step S101 to continue checking the timer.

### (Step S111)

In the case where an ordinary command has been received during the command transmission suspension time, the status check disabled response notifying unit 120 carries out a response process of a status check disabled.

The status check disabled response notifying unit 120 makes a response of disabled execution, in the case of having received a command, which the security device 20 needs to handle, from the host device 2 and/or the peripheral device 3 and the like. In other words, the status check disabled response notifying unit 120 makes a response to the device outside the master device 10, in order to inform that the command cannot be executed. Meanwhile, the status check disabled response notifying unit 120 does not send any command to the security device 20. Thus, the security device 20 has no chance of making a response to a command, during the specified command transmission suspension time.

Then, the status check disabled response notifying unit 120 returns operation to Step S101 to continue checking the timer. Incidentally, at the time when the command transmission suspension time has elapsed, the master device 10 restarts command transmission, and also make a response, as usual, to a command from any other device within the information processing system ‘X’. The command handling process by the master device 10, according to the embodiment of the present invention, finishes in the way as described above.

### (Command Handling Process by the Security Device 20)

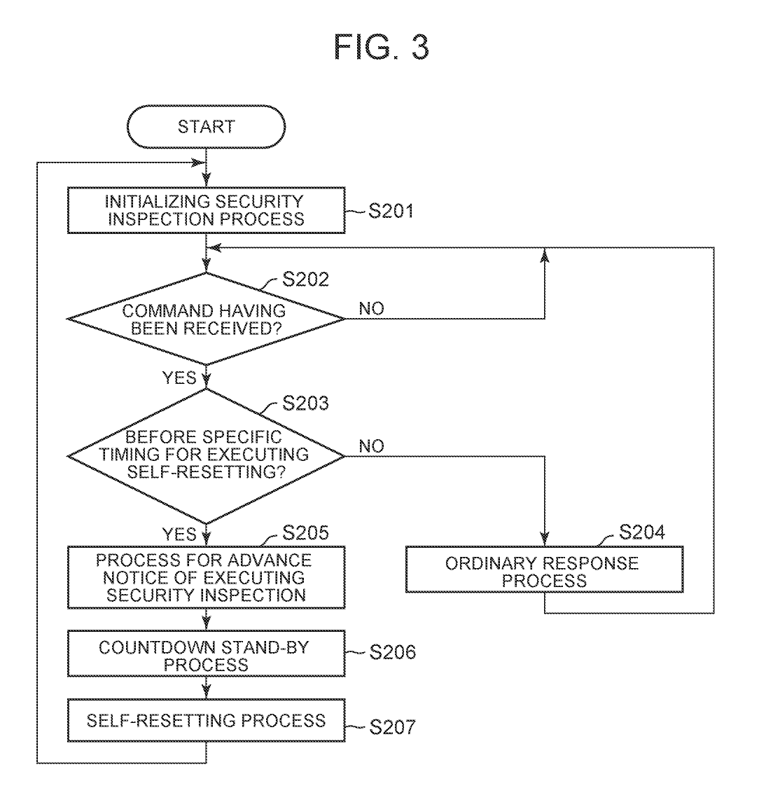

Next, a command handling process to be executed by the security device 20 according to the embodiment of the present invention is explained with reference to FIG. 3.

In the command handling process according to the present embodiment, a security inspection is periodically executed by way of self-resetting. At a time just before a specific timing of countdown for executing the self-resetting, an advance notice of executing the security inspection is sent to the master device 10, while the advance notice is included in a response to the command. On the other hand, if it is not just before the self-resetting, a response is made to the ordinary command or the status check command, having been sent from the master device 10. The command execution process according to the present embodiment is executed in collaboration with each unit by using a hardware resource, while the control unit 21 of the security device 20 mainly executes the control program that is stored in the built-in storage medium. Each step of the command execution process is explained below in detail, with reference to the flowchart of FIG. 3.

### (Step S201)

At first, the security inspection unit 200 carries out an initializing security inspection process.

If once the control unit 21 of the security device 20 gets reset or started, at first, an execution starts from a first address in a memory space of the storage medium. Then, the security inspection unit 200 carries out an initializing process for each unit. The security inspection unit 200 checks, for example, whether each circuit of the security device 20 is free from any illegal modification. Moreover, the security inspection unit 200 calculates a hashing value, a CRC value, and the like; of a program and data of the storage medium built-in, in order to carry out authenticity checking by way of judging whether these values have consistency.

Moreover, the security inspection unit 200 sets an initial value for the timer built in the security device 20.

Incidentally, the security inspection unit 200 is able to execute a security check, also with respect to the master device 10.

### (Step S202)

Next, the status check information sending unit 210 makes a judgment on whether or not a command has been received. In the case of having received a command from the master device 10, the status check information sending unit 210 makes a judgment with ‘Yes’. Meanwhile, in the case of having received no command from the master device 10, the status check information sending unit 210 makes a judgment with ‘No’.

In the case of ‘Yes’, the status check information sending unit 210 moves operation to Step S203.

In the case of ‘No’, the status check information sending unit 210 stands by, until a command is received.

### (Step S203)

In the case of having received a command, the status check information sending unit 210 judges whether or not it is before a specific timing of countdown for executing the self-resetting. By reference to the timer, the status check information sending unit 210 makes a judgment with ‘Yes’, at a time just before a specific timing of the specific inspection time interval; in other words, at a time just before a specific timing of countdown for executing the self-resetting. Then, in any other case, the status check information sending unit 210 makes a judgment with ‘No’.

In the case of ‘Yes’, the status check information sending unit 210 moves operation to Step S205.

In the case of ‘No’, the status check information sending unit 210 moves operation to Step S204.

### (Step S204)

If it is not at a time just before a specific timing of countdown of the specific inspection time interval, the status check information sending unit 210 carries out an ordinary response process. The status check information sending unit 210 creates status check information, and makes a response, to a status check command. The status check information sending unit 210 can also make a judgment on information with respect to the card reader 1 having been dismounted, disassembled, and the like, in order to include the judgment in the status check information. Furthermore, the status check information sending unit 210 also makes a response to an ordinary command. At the time, the status check information sending unit 210 makes a response, including a datum as a result of encoding/decoding and the like, with respect to a datum obtained from the master device 10.

### (Step S205)

If it is at a time just before a specific timing of countdown for executing the self-resetting, the status check information sending unit 210 carries out a process for an advance notice of executing the security inspection. The status check information sending unit 210 creates the status check information indicating an advance notice of executing the security inspection, and makes a response to the status check command. Specifically to describe, the status check information sending unit 210 sends the status check information including a flag and the like, indicating that it is just before self-resetting, as a response to the status check command.

Moreover, the status check information sending unit 210 creates status check information indicating an advance notice of executing the security inspection, and makes a response, with respect to an ordinary command as well. At this time, it is possible for the status check information sending unit 210 to create the datum including a flag and the like, indicating that it is just before self-resetting, in addition to the datum that is the same as in the ordinary response process of Step S204 described above, in order to make a response. In this way, the status check information sending unit 210 makes a response to announce beforehand that self-resetting operation soon starts.

### (Step S206)

Next, the security inspection unit 200 carries out a countdown stand-by process.

While measuring time by using the timer, the security inspection unit 200 suspends operation for a period of a specific time for a countdown, and stands by. Thus, the security inspection unit 200 carries out a so-called ‘countdown’ until self-resetting operation.

### (Step S207)

Next, the security inspection unit 200 carries out a self-resetting process. After the countdown, the security inspection unit 200 carries out self-resetting operation. The security inspection unit 200 can reset software-wise, for example, by such a way of writing a special register for resetting, and setting a value of a program counter with ‘0’, and the like. Meanwhile, it is also possible for the security inspection unit 200 to reset by way of sending a signal to an external terminal connected to a reset terminal.

Then, having restarted, the control unit 21 of the security device 20 returns operation to Step S201, and executes initialization and a security inspection. In other words, according to the present embodiment, the control program is executed from its beginning of a memory space by way of self-resetting. Then, while a series of initializing steps at the time of startup are executed, the security inspection is executed in course of the steps. The command handling process by the security device 20, according to the embodiment of the present invention, finishes in the way as described above.

### Primary Advantageous Effect of the Present Embodiment

According to a configuration described above, an effect can be obtained as described below. In a conventional information processing device; while a security device is executing a security inspection, a master device cannot gain access to the security device so that a communication failure happens. In other words, the master device cannot judge whether the status is because of a security inspection or owing to the security device being out of order.

In the meantime, an information processing device according to the embodiment of the present invention is the card reader 1 including the master device 10 and the security device 20; wherein the master device 10 includes the status checking unit 100 for repeatedly sending a status check command to the security device 20, and the status check information receiving unit 110 for receiving status check information from the security device 20, the status check information being in response to the status check command sent by the status checking unit 100; and then, the security device 20 includes the security inspection unit 200 for periodically executing a security inspection, and the status check information sending unit 210 for sending status check information indicating an advance notice of executing the security inspection, to the master device 10, as a response to the status check command, at a time just before a specific timing of countdown for executing the security inspection by the security inspection unit 200.

According to this configuration, it becomes possible for the master device 10 to judge whether a status is in a security inspection or owing to the security device 20 being out of order. Therefore, stability of the card reader 1 can be improved. Moreover, in the case of a breakdown of the security device 20, the master device 10 can immediately notify the host device 2 of the breakdown for dealing with the incident.

Furthermore, in the card reader 1 according to the embodiment of the present invention, the security inspection unit 200 of the security device 20 periodically carries out self-resetting so as to execute a security inspection at the time of startup. In other words, at a time just before the self-resetting, the security device 20 notifies the master device 10 of the status, so that the master device 10 can notice that the security device 20 is about to carry out the self-resetting.

In this way, a communication failure caused by the self-resetting of the security device 20 is avoided, in such a way that no false recognition happens so as not to recognize the status to be a hardware error of the security device 20, in order to continue stable operation.

Moreover, in the card reader 1 according to the embodiment of the present invention; in the case where status check information received by the status check information receiving unit 110 indicates an advance notice of executing a security inspection, the status checking unit 100 of the master device 10 suspends transmission of a command for a period of a specific time for a countdown and a process time for the security inspection.

According to this configuration, the security device 20 does not need to receive a command in the security inspection, and therefore processing efficiency of the security inspection can be improved. Thus, a time starting from the self-resetting until the security device 20 becomes ready for operation can be shortened. Moreover, the security inspection itself can be protected against being disturbed with an illegal access during the security inspection, and the security can be further improved, and stability of the entire system can be increased.

Moreover, in the card reader 1 according to the embodiment of the present invention; the master device 10 is provided with the status check disabled response notifying unit 120 for making a response to the host device 2 and/or the peripheral device 3, notifying that the command cannot be executed, in the case of having received the command to be executed by the security device 20, from the host device 2 and/or the peripheral device 3, during the command transmission suspension time by the status checking means.

According to this configuration, the master device 10 can avoid recognizing wrongly that a status is in a hardware error, although the security device 20 is actually in a security inspection, so as to notify the host device 2 and/or the peripheral device 3 in the information processing system ‘X’ of the wrong recognition, in such a way that, as a result, the information processing system ‘X’ stops operation as a whole. Furthermore, it is not necessary to change an application, a control program, and the like of the host device 2 in accordance with the self-resetting of the security device 20; and therefore, the stability can be increased, and a development cost can be reduced.

### Other Embodiments

In the embodiment mentioned above; as a concrete example, self-resetting operation is explained as the security inspection of the security device 20. Alternatively, the security inspection may be executed by use of any method other than self-resetting. For example, a dedicated control program for inspection, such as a sub-routine and a ‘class’ may be executed.

According to this configuration, it becomes unnecessary to execute any process, such as initialization and the like, other than the security inspection; so that the security inspection can be executed efficiently.

Moreover, in the embodiment mentioned above, an explanation is made with respect to a case example in which a fixed time interval is specified as the specific inspection time interval for the security inspection. Furthermore, in the example explained, the specific time interval for checking a status is also fixed. Alternatively, the specific inspection time interval as well as the specific time interval may not be fixed values. Specifically to describe, the interval until the self-resetting for the security inspection can be changed in operation, according to contents of encoding/decoding operations, the number of operations, and the like. Moreover, an interval for sending the status check command to the security device 20 can also be changed, for example, according to a status of a power supply, such as a power-saving mode, etc., an operation status of the information processing system ‘X’, and the like.

According to this configuration; the information processing system ‘X’ can be provided, being with a processing load controlled, with safety improved, and with efficiency enhanced.

Moreover, in the embodiment mentioned above, an explanation is made with respect to a case example in which operation is executed according to a response to a command, as an advance notice of executing the security inspection. Alternatively, with a signal line being provided between the master device 10 and the security device 20, an advance notice of executing the security inspection may be notified by means of a method of switching a high/low level of the signal, and the like. In other words, by using the signal line, operation can be dealt with in the same way as in the command transmission described above. Furthermore, also for the communication between the main board and the security board, various methods can be applied.

According to this configuration; in the master device 10, an advance notice of executing the security inspection can be recognized, without analyzing a response to a command. Moreover, a processing load can be reduced, and processing efficiency for a command can be improved.

Moreover, in the embodiment mentioned above; although sending the status check information and receiving the advance notice of executing the security inspection are explained from a viewpoint in relations between the master device 10 and the security device 20, the transmission is not limited to the relations between those devices. In other words, the same configuration can also be applied to relations between the host device 2 and the card reader 1. Furthermore, the master device 10 can also send a response indicating that a security inspection is in execution, or a security inspection has already been executed, to the host device 2 and/or the peripheral device 3.

According to this configuration, it is possible to deal with a security inspection in a flexible manner. Moreover, it becomes possible for the host device 2 and/or the peripheral device 3 to notice execution of a security inspection, so that an appropriate response can be made, such as showing a message to a user, and the like. Furthermore, since the master device does not need to answer with a “busy” response, and the like, processing efficiency can be improved. Still further, the host device 2 and/or the peripheral device 3 can notice with regard to a security inspection; and therefore it becomes possible to carry out an initializing process, a process of demanding a confirmation on initialization already done, and the like, with respect to the host device 2 and/or the peripheral device 3, at the right timing.

Moreover, in the embodiment mentioned above, an explanation is made with respect to a configuration in which the security device 20 for executing a security inspection is a slave device. Alternatively, any circuit other than the security device 20, and the like can be used as a slave device.

According to this configuration; even in the case of a slave device other than the security device 20, the master device 10 can easily notice a status at a time when no response can be made because of self-resetting, and the like.

Incidentally, configuration and operation of the embodiment described above are just an example, and it is clear that the configuration and operation can arbitrarily be changed and executed, without departing from the concept of the present invention.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An information processing device comprising:
a master device; and
a security device;
wherein the master device comprises:
a status checking means for repeatedly sending a status check command to the security device; and
a status check information receiving means for receiving status check information from the security device, the status check information being in response to the status check command sent by the status checking means; and
the security device comprises:
a security inspection means for periodically executing a security inspection; and
a status check information sending means for sending status check information indicating an advance notice of executing the security inspection, to the master device, as a response to the status check command, at a time just before a specific timing for executing the security inspection by the security inspection means.

2. The information processing device according to claim 1;
wherein, the security inspection means of the security device executes a security inspection at the time of startup, by means of periodically carrying out self-resetting.

3. The information processing device according to claim 1;
wherein, in the case where status check information received by the status check information receiving means indicates an advance notice of executing the security inspection, the status checking means of the master device suspends transmission of the command for a period of the specific time and a process time for the security inspection.

4. The information processing device according to claim 3;
wherein, the master device includes a status check disabled response notifying means for making a response to an outside, notifying that the command cannot be executed, in the case of having received the command to be executed by the security device, from the outside, during the command transmission suspension time by the status checking means.

5. An information processing method to be executed by an information processing device including a master device and a security device, the method comprising:
repeatedly sending, with the master device, a status check command to the security device; and
receiving, with the master device, status check information, being in response to the sent status check command, from the security device; and
periodically executing a security inspection with the security device; and
sending, with the security device, status check information notifying of executing the security inspection, to the master device, as a response to the status check command, at a time just before a specific timing for executing the security inspection.

6. An information processing device comprising:
a master circuit; and
a security circuit;
wherein the master circuit comprises:
a status checking circuit configured to repeatedly send a status check command to the security circuit; and
a status check information receiving circuit configured to receive status check information from the security circuit, the status check information being in response to the status check command sent by the status checking circuit; and
the security circuit comprises:
a security inspection circuit configured to periodically execute a security inspection; and
a status check information sending circuit configured to send status check information indicating an advance notice of executing the security inspection, to the master circuit, as a response to the status check command, at a time just before a specific timing for executing the security inspection by the security inspection circuit.
